(19) United States
(12) Patent Application Publication
(10) Pub. No.: US 2025/0205568 A1
(43) Pub. Date: Jun. 26, 2025

(54) POWERED GOLF BAG ASSEMBLY

(71) Applicant: Zero Friction, LLC, Oak Brook Terrace, IL (US)

(72) Inventors: John R. Iacono, Elmhurst, IL (US); Alistair S. Patterson, Cheltenham (GB)

(73) Assignee: Zero Friction, LLC, Oak Brook Terrace, IL (US)

(21) Appl. No.: 18/848,087

(22) PCT Filed: Mar. 24, 2023
(86) PCT No.: PCT/US2023/064964

§ 371 Date: Sep. 17, 2024

Related U.S. Application Data
(60) Provisional application No. 63/481,173, filed on Jan. 23, 2023.
(60) Provisional application No. 63/323,312, filed on Mar. 24, 2022.

(51) Int. Cl. A63B 55/60; A63B 55/40; B60K 7/00; B60L 50/60

(52) U.S. Cl. CPC A63B 55/61; A63B 55/40; A63B 2055/602; A63B 2055/605; B60K 7/0007; B60K 2007/0092; B60L 50/60; B60L 2200/30

(57) ABSTRACT

A golf bag assembly that is self-powered and stable, having a relatively small footprint. Because of its compactness, the golf bag assembly is relatively easy to collapse, handle, maneuver and transport. Also, the golf bag assembly may include a tracking system that allows a user to use the assembly remotely or in a mode where the golf bag assembly follows the user. Further, a club bag of the golf bag assembly may be integrated with a bag transport assembly.

### CROSS-REFERENCES TO RELATED APPLICATIONS

This application claims priority from the following US patent applications: this application claims priority to, and the benefit of, U.S. Provisional Patent Application Ser. No. 63/323,312, filed Mar. 24, 2022; and U.S. Provisional Patent Application Ser. No. 63/481,173, filed Jan. 23, 2023, which are both incorporated by reference herein in their entirety.

### BACKGROUND

Self-powered golf carts and trolleys have been around for a number of years, and many of these are collapsible and portable. However, these prior carts and trolleys typically require a fairly large base footprint for stability and to accommodate the golf bag placed on them. The golf bag is a separate piece of equipment from the cart or trolley, and these prior carts and trolleys are not capable of being placed directly on the back of a golf cart with the golf bag in place for use due to their large footprint. Also, these prior carts and trolleys are very cumbersome to collapse and handle and difficult to maneuver. They are also very difficult to transport. Accordingly, there is a need for a powered golf bag assembly that is self-powered, less cumbersome, more maneuverable and easily portable.

### SUMMARY

According to one aspect of the subject matter described in this disclosure, a powered golf bag assembly includes a club bag and a bag transport assembly integrated with the club bag, where the bag transport assembly includes a foldable rear wheel support brace and a power chassis. The foldable rear wheel support brace includes a plurality of wheels and the power chassis includes a battery; a controller; and a plurality of hub motors in communication with the battery and the controller. The powered golf bag assembly may also include a plurality of removeable wheels that each correspond to a hub motor, where the removeable wheel can be removed from or installed on a corresponding hub motor. According to another aspect of the subject matter described in this disclosure, each hub motor of the powered golf bag assembly may have splines formed thereon around the outer diameter, and each corresponding removeable wheel may have female spline cups formed therein, to engage the splines of the corresponding hub motor when the removeable wheel is installed. The powered golf bag assembly may have a battery that is removeable, and may have an antenna disposed in the bag transport assembly and a remote; where the antenna and the remote interact with one another to track and control the powered golf bag assembly. The antenna may be ultra-wide band. The hub motors may operate independent of one another. Further, the club bag of the powered golf bag assembly may have a top and when the foldable rear wheel support brace is folded against the club bag, the highest point of the foldable rear wheel support brace is below the top of the club bag.

According to another aspect of the subject matter described in this disclosure, a powered golf bag assembly includes a club bag having a compartment; a battery; a controller, where the battery and the controller are configured to be carried in the compartment of the club bag; a foldable handle; a foldable rear wheel support brace having a plurality of wheels, where the foldable handle and foldable rear wheel support brace are integrated with the club bag and a pair of front wheels having a hub motor for each wheel; where each hub motor is in communication with the battery and the controller and the pair of front wheels connect to the club bag. Further, the pair of front wheels may be removeable from the club bag.

According to yet another aspect of the subject matter described in this disclosure, a powered golf bag assembly includes a club bag having a base with a defined width; a bag transport assembly configured to connect to the club bag, where the bag transport assembly includes a foldable rear wheel support brace and a power chassis and where the foldable rear wheel support brace includes a plurality of wheels and the power chassis has a top portion that has a defined width that is approximately the same width as the base of the club bag The power chassis includes a battery; a controller; a shell; and a pair of hub motors in communication with the battery and the controller and mounted external to the shell; where, when mounted external to the shell, each hub motor has an outer edge and the width defined from outer edge of the first hub motor to the outer edge of the second hub motor is less than the width of the base of the club bag. The defined width of the base of the club bag may be approximately 267.7 millimeters. The plurality of wheels of the foldable rear wheel support brace may be a pair of wheels and each wheel of the foldable rear wheel support brace may have an outer edge and the width defined from the outer edge of the first wheel of the foldable rear wheel support brace to the outer edge of the second wheel of the foldable rear wheel support brace may be approximately 462 millimeters. Further, the powered golf bag assembly may include a pair of removeable wheels that each correspond to one of the hub motors, where the removeable wheel can be removed from or installed on a corresponding hub motor. Each removeable wheel has an outer edge and the width defined from outer edge of the first removeable wheel to the outer edge of the second removeable wheel may be approximately 585.5 millimeters. In addition, the club bag has a centerline, and the pair of removeable wheels define a central axis between them, and the club bag centerline may extend forward of the central axis of the removeable wheels. Also, the shell has a forwardmost point and where, when the club bag is in an inclined position, no portion of the club bag extends in front of the forwardmost point of the shell.

### DRAWINGS

Objects, features, and advantages of the present invention will become apparent upon reading the following description in conjunction with the drawing figures, in which:

FIG. 1 is a perspective view of an embodiment of the golf bag assembly of the present invention in a transport configuration, depicting a set of front wheels removed;

FIG. 2A is a perspective view of the embodiment of the golf bag assembly of the present invention in a collapsed configuration;

FIG. 2B is a rear elevation view of the embodiment of the golf bag assembly of the present invention in the collapsed configuration;

FIG. 3A is a perspective view of the embodiment of the golf bag assembly of the present invention in the powered configuration;

FIG. 3B is a right side elevation view of the powered use configuration embodiment of the golf bag assembly of the present invention illustrating a bag axis and a forwardmost point of a power chassis;

FIG. 3C is a front elevation view of the embodiment of the golf bag assembly of the present invention in the powered configuration;

FIG. 3D is a rear elevation view of the embodiment of the golf bag assembly of the present invention in the powered configuration;

FIG. 4A is a front perspective view of the push configuration embodiment of the golf bag assembly of the present invention;

FIG. 4B is a rear perspective view of the push configuration embodiment of the golf bag assembly of the present invention;

FIG. 5 depicts an exploded view of an embodiment the golf bag assembly of the present invention;

FIG. 6A is a sectional view which illustrates an embodiment of an engagement of a club bag with a bag transport assembly;

FIG. 6B is a sectional view which further illustrates the embodiment of an engagement of a club bag with a bag transport assembly;

FIG. 7A is a sectional view which illustrates the interaction of the bottom of the club bag with a cover for the components of the power chassis;

FIG. 7B is a sectional view which further illustrates the interaction of the bottom of the club bag with a cover for the components of the power chassis;

FIG. 8A depicts a power chassis of an embodiment of the golf bag assembly of the present invention with a cover in place on the chassis;

FIG. 8B depicts a power chassis of an embodiment of the golf bag assembly of the present invention which has hub motors disposed within the power chassis;

FIG. 8C depicts a power chassis shell of an embodiment of the golf bag assembly of the present invention which has hub motors disposed external to a shell of the power chassis;

FIG. 8D depicts a schematic of a power chassis and a pair of hub motors in an embodiment of the golf bag assembly of the present invention;

FIG. 9 is a perspective view depicting a removeable battery unit of a power chassis in an embodiment of the golf bag assembly of the present invention;

FIG. 10A is another perspective view depicting the removeable battery unit of the power chassis in an embodiment of the golf bag assembly of the present invention removed;

FIG. 10B is a perspective view depicting a removeable battery unit in an embodiment of the golf bag assembly of the present invention;

FIG. 11A depicts the power chassis, hub motor and front wheel interaction, with the front wheels installed, in an embodiment of the golf bag assembly of the present invention;

FIG. 11B depicts the power chassis, hub motor and front wheel interaction, with the front wheels removed, in an embodiment of the golf bag assembly of the present invention;

FIG. 12A is a rear view of the power chassis and hub motors in an embodiment of the golf bag assembly of the present invention;

FIG. 12B is a rear view of the power chassis and hub motors, with the front wheels installed, in an embodiment of the golf bag assembly of the present invention;

FIG. 13A illustrates the hub motor and the front wheel interaction in an embodiment of the golf bag assembly of the present invention;

FIG. 13B further illustrates the hub motor and the front wheel interaction in an embodiment of the golf bag assembly of the present invention;

FIG. 14A illustrates the front wheel in a disengaged configuration in an embodiment of the present invention;

FIG. 14B illustrates the front wheel in an engaged configuration in an embodiment of the present invention; and

FIG. 15 is a side view of another embodiment of golf bag assembly of the present invention.

### DESCRIPTION

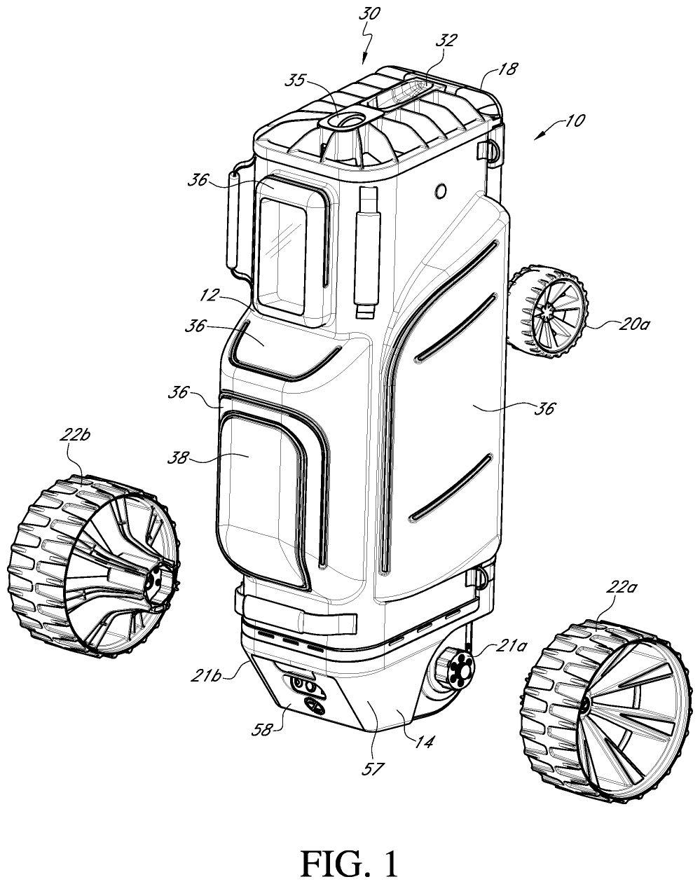

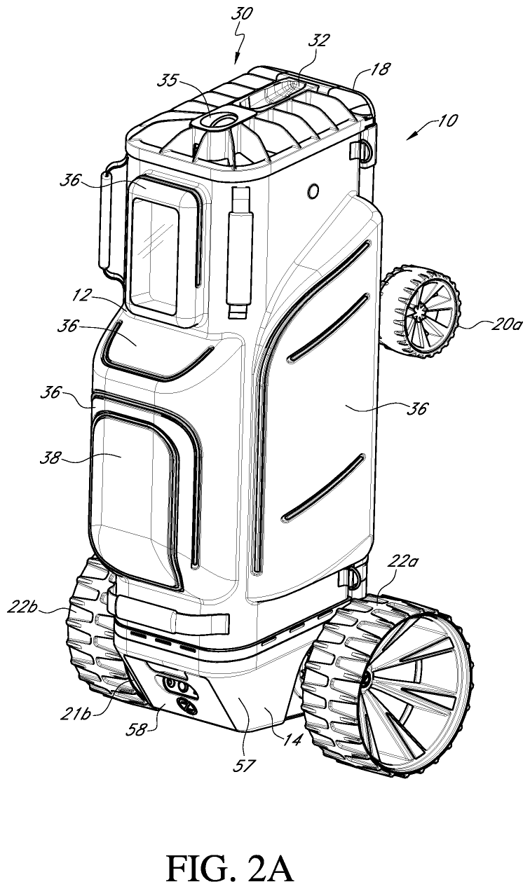

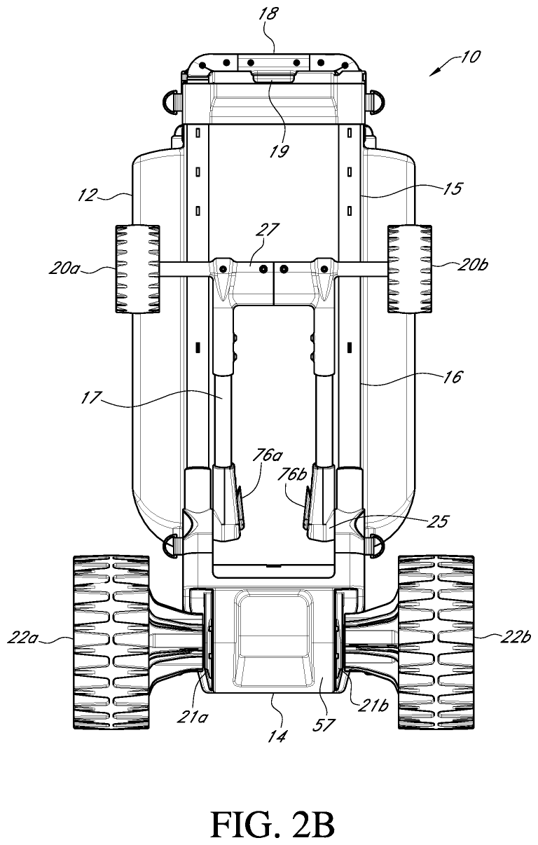

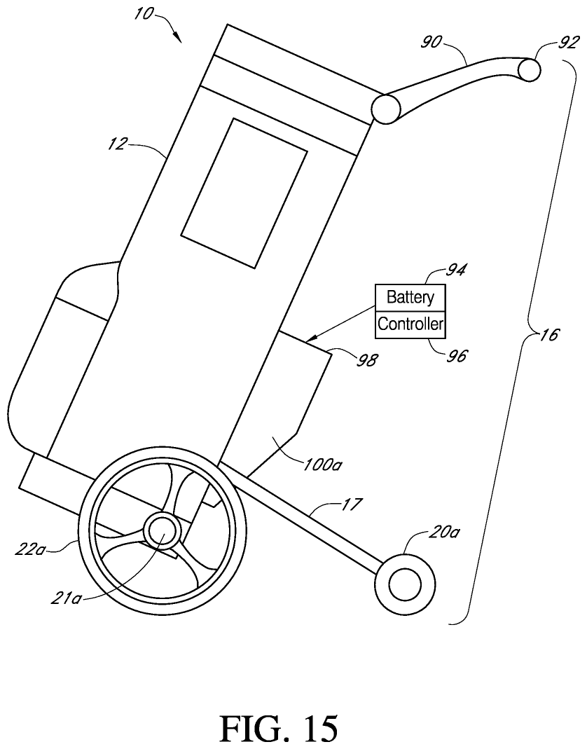

Referring to FIGS. 1-4B, an embodiment of a golf bag assembly 10 of the present invention is depicted. Referring specifically to FIGS. 1-2B, the golf bag assembly 10 of this embodiment includes, among other items, a club bag 12 and a bag transport assembly 16 having a power chassis 14, a rear bag support frame 15 housing a telescopic handle 18, a rear wheel support brace 17, a pair of rear wheels 20a, 20b, a pair of hub motors 21a, 21b and a pair of front wheels 22a, 22b. The power chassis 14 also includes a battery unit 58, which may be removeable from the power chassis 14, as is explained further below. In a preferred embodiment explained in more detail below, the pair of front wheels 22a, 22b are removeable from the bag transport assembly 16. In this preferred embodiment, to do this, the front wheels 22a, 22b are spring released from the hub motors 21a, 21b. Further, the bag transport assembly 16 of the present invention maybe a structure separate from the club bag 12 that may or not be integrated with the club bag 12 or, in other embodiments, the bag transport assembly 16 may have its components integrated directly with the club bag 12 (FIG. 15). For instance, in one embodiment as depicted in FIG. 15, a handle 90 and the rear wheel support brace 17 are integrated with the top and bottom of the club bag 12, respectively, with both folding outward to extend away from the club bag 12 when in use.

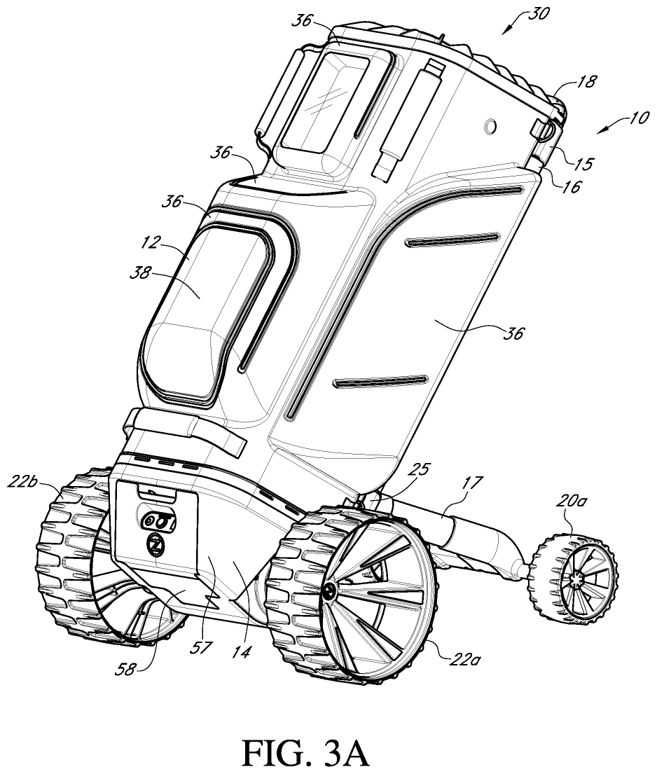

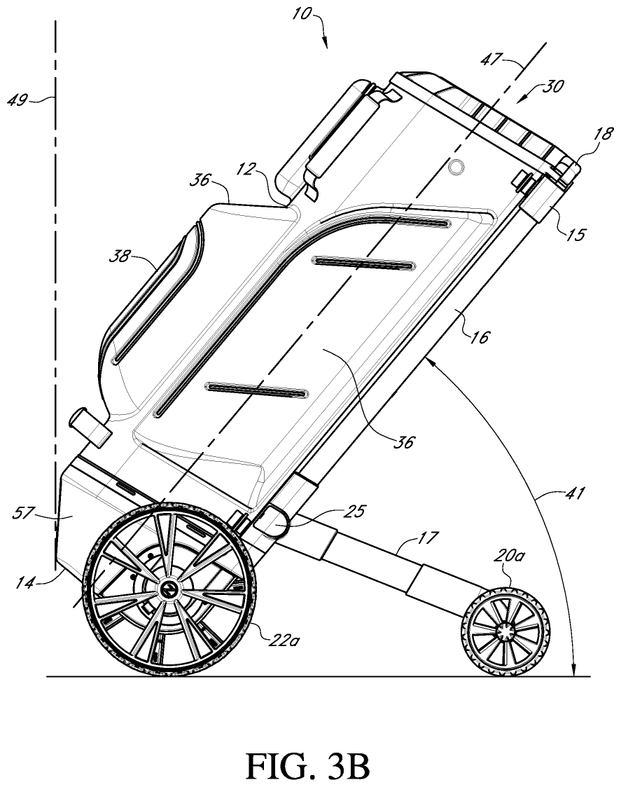

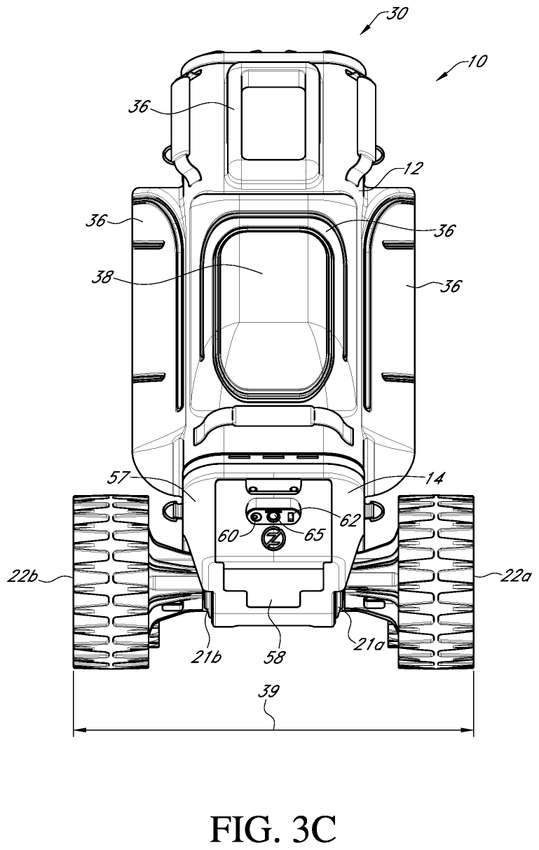

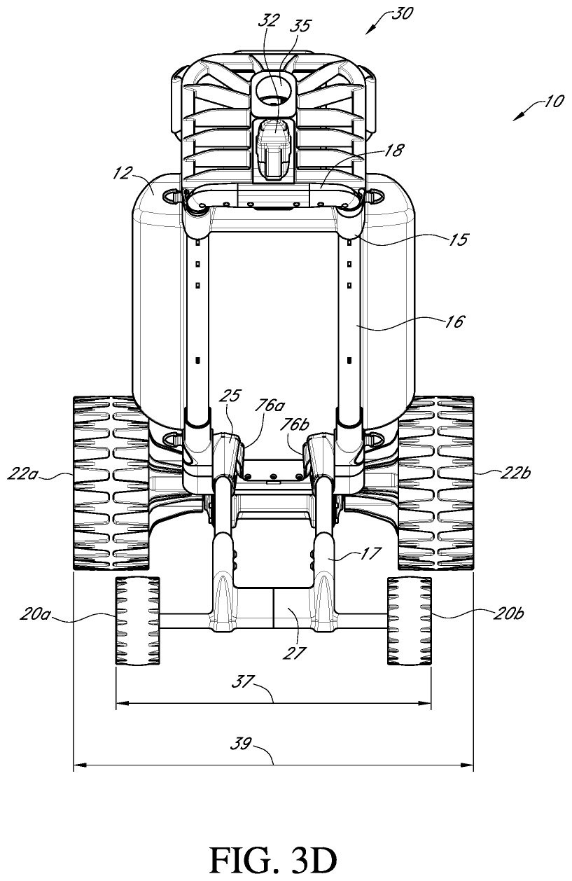

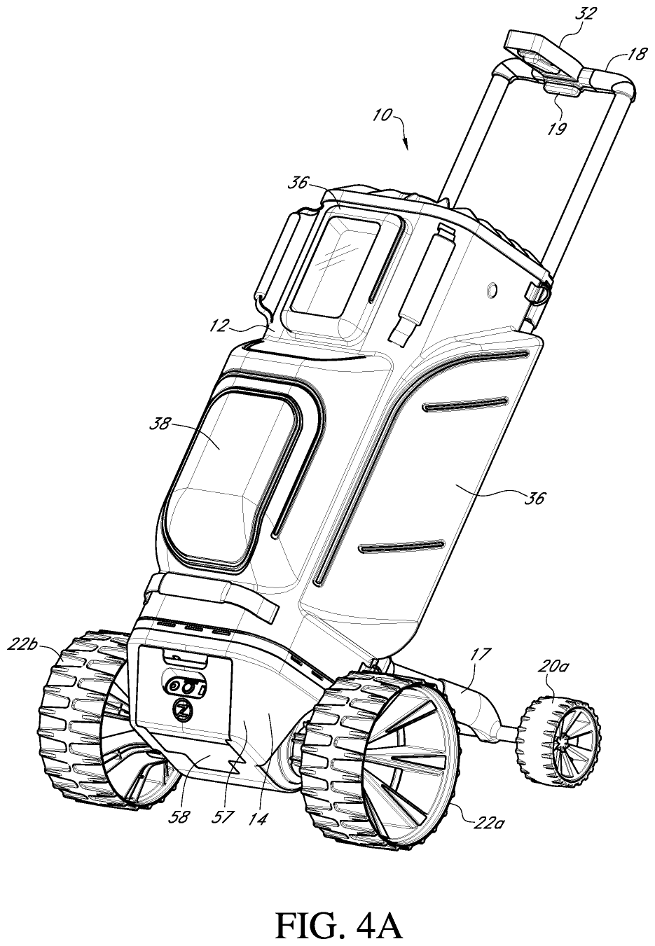

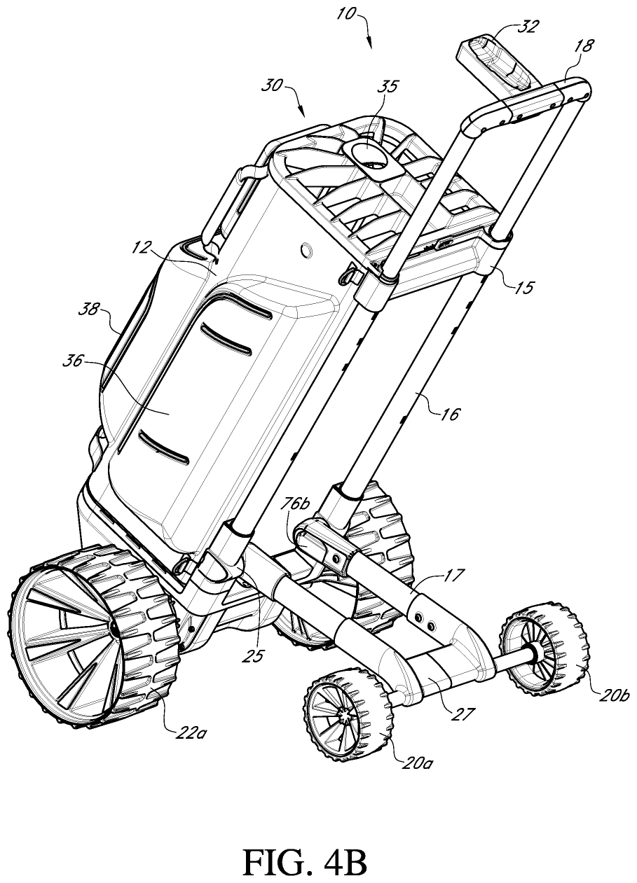

As depicted in FIGS. 1, 2A-2B, 3A-3D and 4A-4B, the golf bag assembly 10 of the present embodiment can be configured into one of four main configurations: 1) Transport Configuration: the golf bag assembly 10 is collapsed; wheels 22a, 22b are off, and the golf bag assembly 10 is ready for transport (FIG. 1) and if desired, the battery unit 58 (explained below) may be removed to reduce the weight of the golf bag assembly 10; 2) Collapsed Configuration: the golf bag assembly 10 is collapsed with the front wheels 22a, 22b on the hub motors 21a, 21b, and the rear wheels 20a, 20b, connected to the rear wheel support brace 17, are folded up against the rear bag support frame 15 (FIGS. 2A-2B); 3) Powered Use Configuration: the rear wheel support brace 17 of the golf bag assembly 10 is folded outward from the rear bag support frame 15, at a pivot point 25, and locked in an extended position (FIGS. 3A-3D); and 4) Push Configuration: as in the Powered Use Configuration, the rear wheel support brace 17 of the golf bag assembly 10 is folded outward and locked in an extended position, but in addition, the telescopic handle 18 is extended upward for use by a user of the golf bag assembly 10 (FIGS. 4A-4B).

Further, the club bag 12 has a number of openings 30 at the top in to which golf clubs can be placed. In this embodiment, the handle 18 also has a tray 32 in which a remote 34 (FIG. 3D), that can be used to control the golf bag assembly 10 (described below), can be placed. The club bag 12 may also include a number of other items, including an opening for an umbrella holder 35 and storage pockets 36 which a golfer can use to store items, such as a smartphone, golf balls, tees, towels or any other item. Also, in this embodiment, the club bag 12 has a pocket 38 that functions as a cooler that can hold drinks and keep them cool for the user during a round of golf. It is foreseen that other storage and accessories could be used with varying embodiments of the present invention.

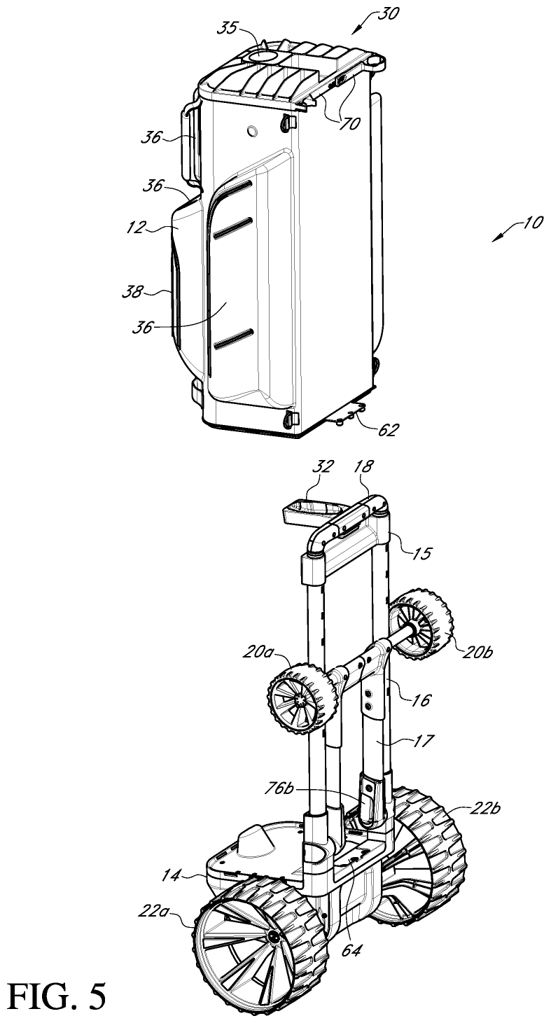

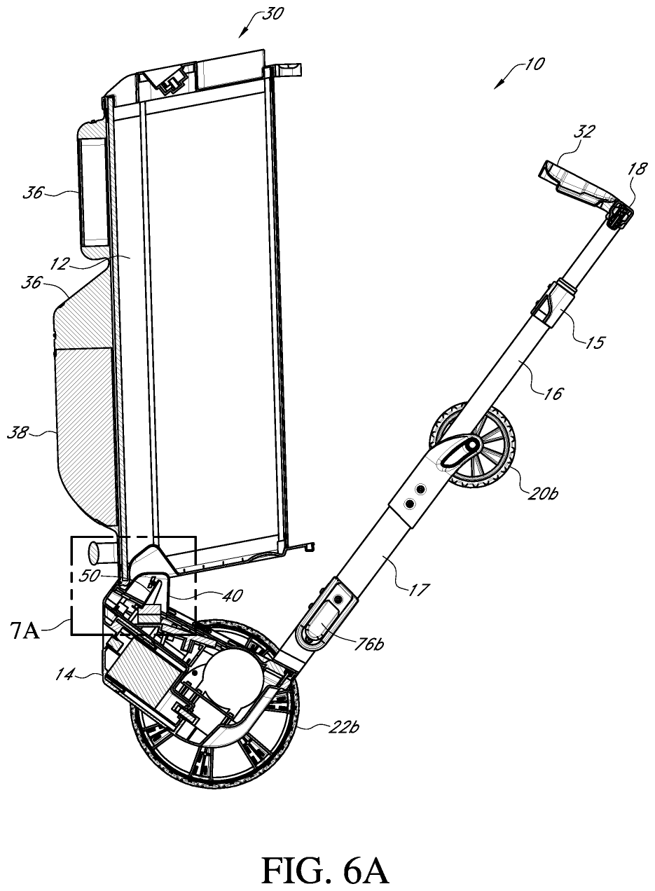

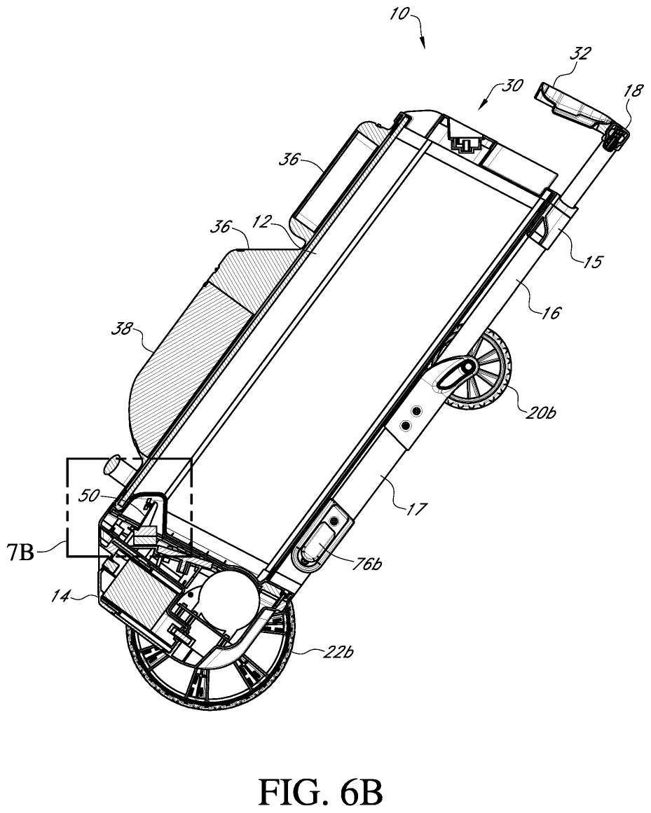

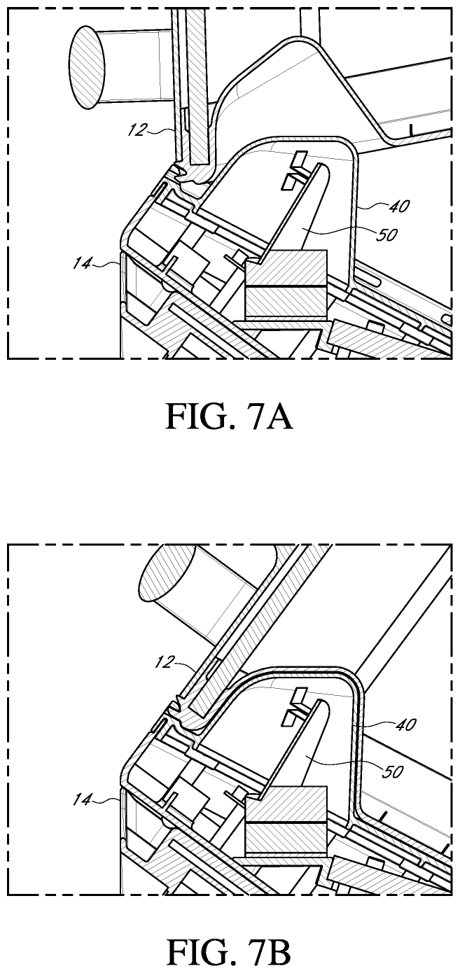

FIG. 5 depicts an exploded view of the golf bag assembly 10 with the club bag 12 and the bag transport assembly 16 separate from one another, and FIG. 2A depicts the golf bag assembly 10 in an assembled configuration. FIGS. 6A-6B are sectional views which illustrate an embodiment of an engagement of the club bag 12 with the bag transport assembly 16. FIGS. 7A-7B are sectional views which illustrate the interaction of the bottom of the club bag 12 with a cover 40 of components of the power chassis 14, which, in this embodiment, includes a tracking antenna 50. In one embodiment, the club bag 12 is securely attached to the bag transport assembly 16 and not meant to be removed. In another embodiment, the club bag 12 and bag transport assembly 16 are configured so that the club bag 12 can be easily detached from the bag transport assembly 16 to be carried separately if the user wants to or if the user wants to attach a different club bag 12 to the bag transport assembly 16. The top of the club bag 12 may be secured to the bag transport assembly 16 in a number of ways. In one embodiment, a pair of handle retainers 70 attached to the club bag 12 are positioned around the bag transport assembly 16 and then fastened back onto the club bag 12, and a bottom flange 62 of the club bag 12 is fastened to a lower portion 64 of the bag transport assembly 16.

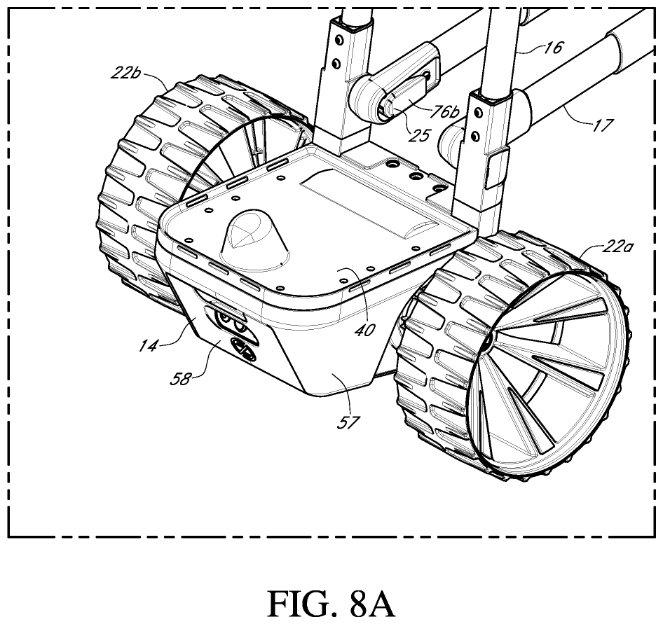

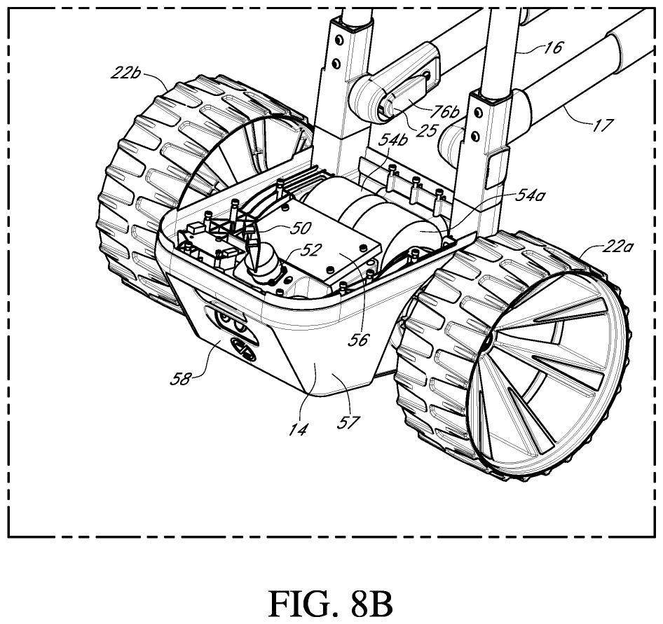

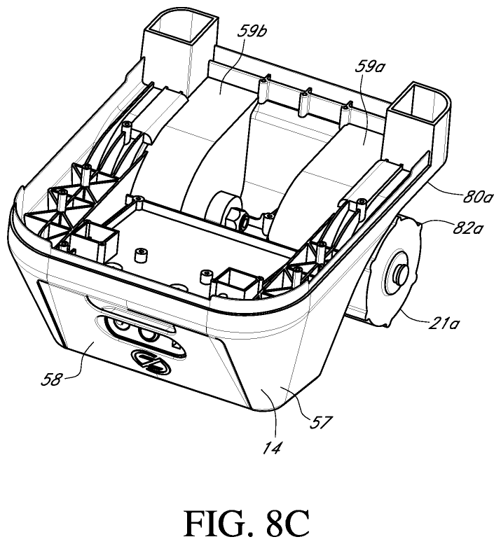

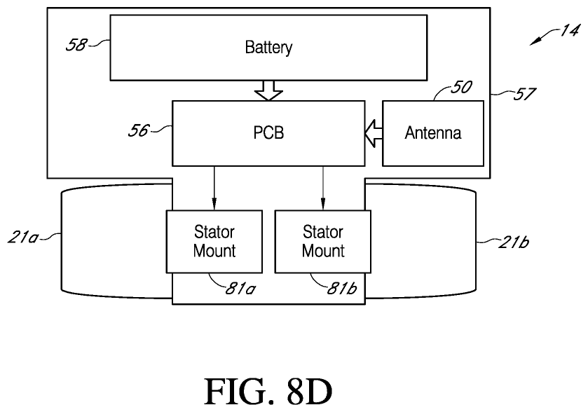

Referring now to FIGS. 8A-8D, embodiments of the power chassis 14 of the golf bag assembly 10 are illustrated. FIG. 8A depicts the golf bag assembly 10 with the cover 40 in place covering the components of the power chassis 14. FIGS. 8B and 8C depict two different embodiments of the power chassis 14. Both embodiments employ brushless direct current motors (“BLDC”), and FIGS. 8B and 8C depict embodiments with the cover 40 to the power chassis 14 removed. The embodiment in FIG. 8B employs a BLDC with a rotor interior to the stator, creating an inner rotation of the rotor, and the embodiment in FIG. 8C employs a BLDC with the rotor outside of the stator, creating an outer rotation of the rotor. Referring to FIG. 8B, in this embodiment, the components of the power chassis 14 include the tracking antenna 50, an antenna block 52, a pair of hub motors 54a, 54b, and a main controller printed circuit board (“PCB”) 56. Referring now to FIG. 8C, the power chassis 14 with the components removed is illustrated. This embodiment has the same components in the same place as the embodiment of FIG. 8B except the hub motors 54a, 54b are BLDC motors 21a, 21b with outer rotation rotors. The hub motors of this embodiment 21a, 21b are now mounted external to a shell 57 of the chassis 40, with each hub motor 21a, 21b engaging with a respective front wheel 22a, 22b. A pair of hub motor forms 59a, 59b formed in the shell 57 define a pair of hub motor recesses 80a, 80b which define an area external to the shell 57 which define respective areas for the hub motors 21a, 21b to be seated in. FIG. 8D is a schematic of the component parts of the power chassis 14 of the embodiment of FIG. 8C, and their connections with one another. The battery unit 58 powers the components of the power chassis 14. The PCB 56 receives inputs from the tracking antenna 50 and controls the speed of the hub motors 21a, 21b. In this preferred embodiment, a stator mount 81a, 81b for each hub motor 21a, 21b is disposed inside the shell 57, and connects with a stator, external to the shell 57, within each hub motor 21a, 21b. Some advantages of the embodiment depicted in FIG. 8C (Outer Rotation Rotor) over the embodiment in FIG. 8B (Inner Rotation Rotor) is that in the embodiment in FIG. 8C, the hub motors 21a, 21b are external to the shell 57 of the power chassis 14 requiring less space within the power chassis 14. Further, the embodiment of FIG. 8C, since it has a stationary stator mount that passes through the shell 57, does not require the complexity associated with accommodating a spinning rotor that protrudes through the shell 57 to engage the front wheels 22a, 22b. Such an embodiment, as depicted in FIG. 8B, requires, in addition to other things, a more intricate sealing arrangement to protect the interior of the power chassis 14.

Further, as described in more detail below, in an embodiment, the tracking antenna 50 interacts with the remote 34 to track and control the golf bag assembly 10. In this embodiment, an ultra-wide band antenna 50 is used and a receiver is used in the remote 34. It is foreseen, though, that various types of known tracking and control systems could be used to track and control the golf bag assembly 10 as the user navigates a golf course, such as ultrasound.

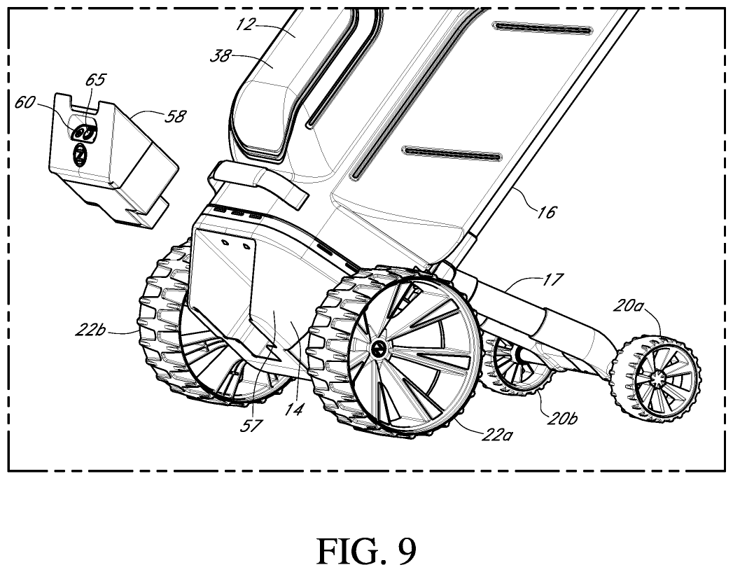

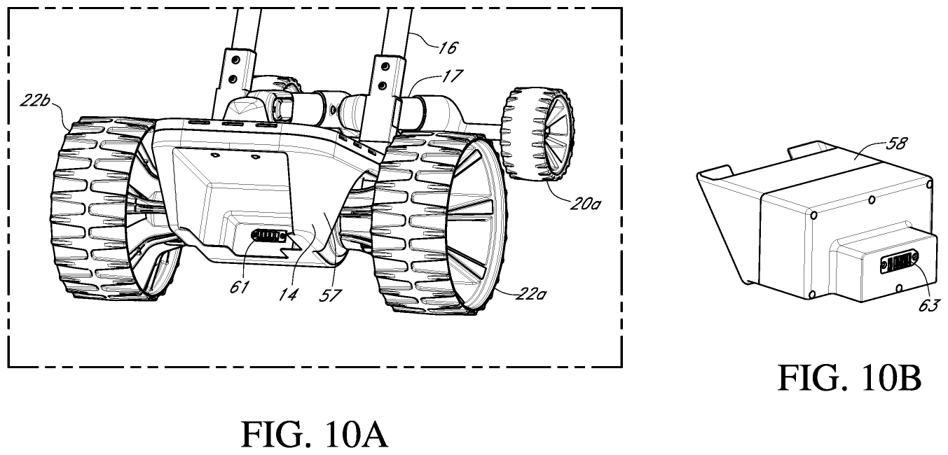

As depicted in FIGS. 9, 10A-10B, and as referred to above, the power chassis 14 also includes the battery unit 58. In one embodiment, the battery unit 58 is removeable and may be slid in and out of the power chassis 14. The power chassis 14, in this embodiment, has a male electrical connector 61 built into it, and the rechargeable battery unit 58 has a female electrical connector built 63 into it. The male connector 61 and the female connector 63 engage with one another when the battery unit 58 is slid into the power chassis 14. The battery unit 58, in this embodiment, is a 24V, 12 Ah, 288 Wh lithium rechargeable battery and is capable of lasting at least 36 holes on the golf course. The battery unit 58 in this embodiment also includes a charging port 60 for recharging the battery, a power indicator illumination button 65 and a USB port 62 that a user can use to re-charge his accessories, such as a smartphone. It should be understood that the battery unit 58 may also include other ports or indicators, such as a battery level indicator that informs a user as to the power remaining on the battery unit 58 before it runs out of power and has to be recharged. Further, the removability of the battery unit 58 of the golf bag assembly 10 of the present invention offers numerous advantages, including portability, if a user of the golf bag assembly 10 wants to remove the front wheels 22a, 22b and use the golf bag assembly 10 as a carry-bag, the user can easily slide the battery unit 58 out of the power chassis 14 to significantly reduce the overall weight of the golf bag assembly 10. The removability of the battery unit 58 also provides the user with the ability to quickly slide the battery out without a technician and slide a new charged battery in, allowing the user to use the golf bag assembly 10 longer than the specified range for just one battery unit 58. Also, having the capability to slide the battery unit 58 out allows the user to charge the battery unit 58 away from the golf bag assembly 10 if desired.

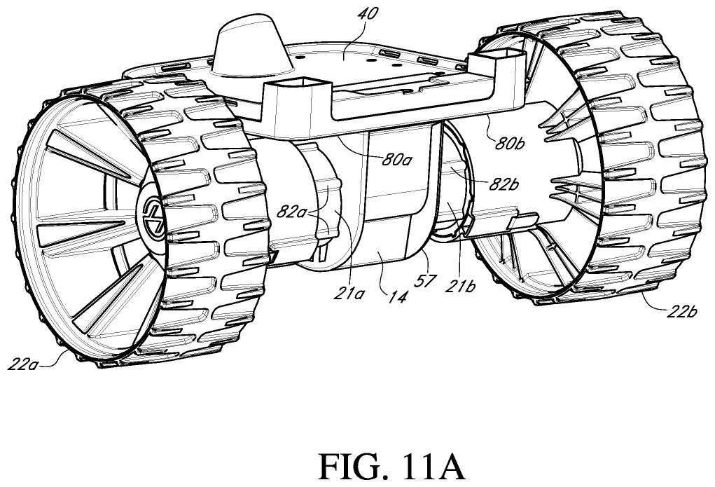

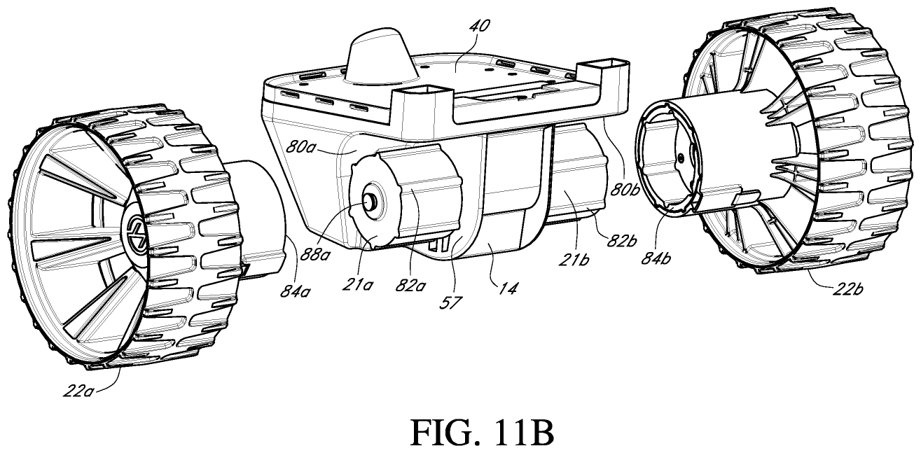

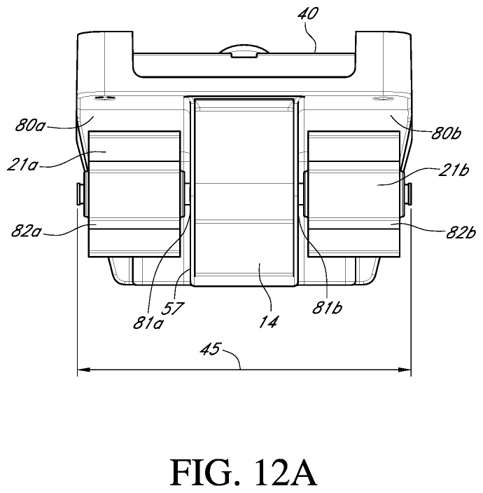

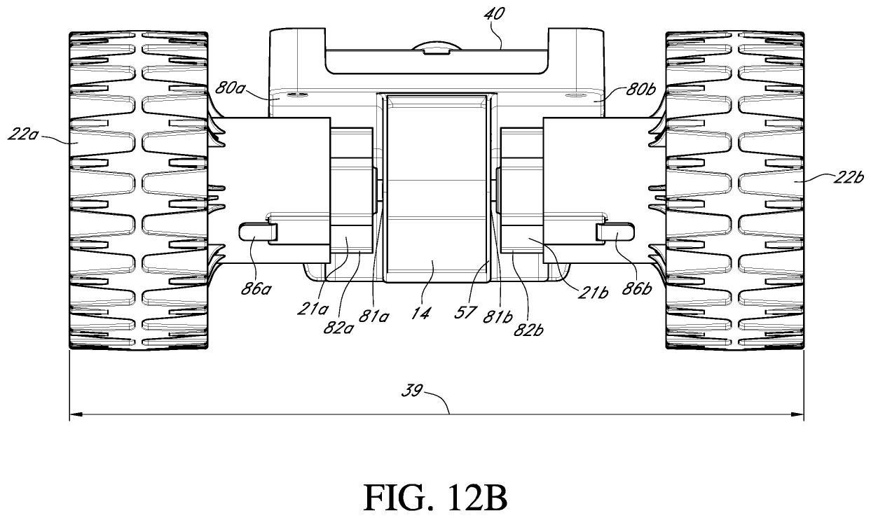

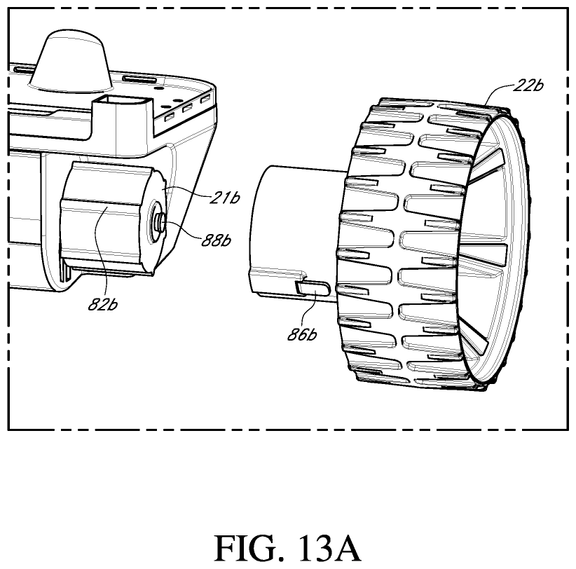

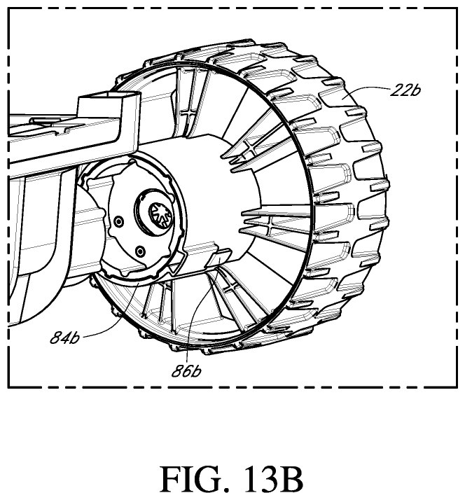

Referring now to FIGS. 11A-14B, the preferred embodiment of FIG. 8C is depicted in more detail. As described above, the battery unit 58 connects with, and powers, the pair of hub motors 21a, 21b that are positioned external to the shell 57 of the power chassis 14 within the pair of hub motor recesses 80a, 80b. The hub motors 21a, 21b operate independently of one another, and as such, each one drives its respective front wheels 22a, 22b independent of one another (i.e. hub motor 21a drives front wheel 22a independent of hub motor 21b driving front wheel 22b). In this configuration, with the separate motors 21a, 21b driving the front wheels 22a, 22b independently, the golf bag assembly 10 can be turned and maneuvered by varying the speed of the independent hub motors 21a, 21b with respect to one another. Further, in this embodiment, the hub motors 21a, 21b have a custom male splined external surface 82a, 82b, and the front wheels 22a, 22b have corresponding female splined cups 84a, 84b to key together and, when connected, engage the front wheels 22a, 22b in rotation. Further, the front wheels 22a, 22b each have a spring-loaded quick release mechanism 86a, 86b (FIGS. 13A-B, 14A-B) that engages with a flange 88a, 88b on the outside of the hub motors 21a, 21b to lock the front wheels 22a, 22b to the hub motors 21a, 21b. Pressing the quick release mechanism 86a, 86b on the front wheels 22a, 22b allows the front wheels 22a, 22b to slide off the hub motors 21a, 21b. In a preferred embodiment, the hub motor width is restricted to approximately no wider than the base of the club bag 12 (FIG. 12A; 45). In this preferred embodiment, in this regard, the width of the base of the club bag 12 is 267.7 mm; the width from flange 88a to flange 88b is 266.5 mm; the distance from the outer edge of front wheel 22a to the outer edge of front wheel 22b is 585.5 mm (FIGS. 3C-3D; 39); the distance from outer edge of rear wheel 20a to the outer edge of rear wheel 20b is 462 mm, (FIG. 3D; 37) and the base angle of the golf bag assembly 10 is 51 degrees (FIG. 3B; 41). It should be understood that the dimensions of the preferred embodiment are exemplary and that the present invention is not limited to the dimensions detailed for this preferred embodiment. As most clearly seen in FIG. 12B, the power chassis 14, in this embodiment, has a lateral dimension that is slightly greater than the lateral dimension between the end faces of the of the respective hub motors 21a, 21b. Further, in this embodiment, the footprint of the upward facing surface of the power chassis 14 matches the footprint of the downward facing surface of the club bag 12, which in this embodiment, mates to the power chassis 14.

This limitation on hub motor width has several advantages. It makes the golf bag assembly 10 capable of being used as carry-bag or placed on the back of a golf cart when the wheels 22a, 22b are removed. It also provides advantages when transporting the golf bag assembly 10. When placing the golf bag assembly 10 in a car trunk or taking it on airplane, the club bag 12 and bag transport assembly 16 can remain attached when in the Transport or Collapsed configurations. Prior cart and trolley systems, because of their width and size, required the golf bag to be separated from the cart or trolley before both could be transported. Further, in this embodiment, the hub motors 21a, 21b stay attached to the power chassis 14, and in turn the club bag 12, when the front wheels 22a, 2b are removed. This simplifies the electronics and increases durability, as no connectors are required.

Referring now back to FIGS. 1-4B, a description of the four configurations of an embodiment of the present invention in use are described. Referring specifically to FIG. 1, the golf bag assembly 10 is the Transport Configuration. The golf bag assembly 10 is folded with the front wheels 22a, 22b removed. The rear wheels 20a, 20b, which are connected to a folding arm 17 of the bag transport assembly 16, are in an upward position with the rear wheels 20a, 20b outside of the rear bag support frame 15 in this embodiment. This configuration puts the bag in the easiest configuration for transporting the golf bag assembly 10, whether it be the user putting the golf bag assembly 10 in his car, taking it on airplane or putting the golf bag assembly on the back of a powered golf cart because the user does not want to walk any further on the course. From the configuration depicted in FIGS. 1, to use the golf bag assembly 10, the user first puts the golf assembly bag 10 into the Collapsed Configuration, depicted in FIGS. 2A-2B. The Collapsed Configuration is similar to the Transport Configuration, except now the front wheels 22a, 22b are attached to their respective hub motors 21a, 21b, and the golf bag assembly 10 is now ready to be unfolded for use in the Powered Use Configuration.

Referring now, specifically to FIGS. 3A-3D, to put the golf bag assembly 10 in the Powered Use Configuration, the user folds the rear wheel support brace 17 of the bag transport assembly 16 outward and downward from the rear bag support frame 15, at the pivot point 25, and locks the rear wheel support brace 17 and the rear wheels 20a, 20b into position. The rear wheel support brace 17 can be locked into position using known locking mechanisms. In one embodiment of the invention, the rear wheel support brace 17 is locked into position using the locking assemblies 76a, 76b. In this tripod position, the golf bag assembly 10 can support itself and can now be used on the golf course. It should be appreciated that the pivot point 25, as in the embodiment depicted, should ideally be at a position low enough to allow the rear wheels 20a, 20b to be folded up within the top height dimension of the club bag 12, but high enough so that the golf bag assembly 10 is stable when the rear wheel support brace 17 is extended and locked. Further, referring to FIG. 3B, in an embodiment of the present invention, the longitudinal axis (centerline) 47 of the club bag 12 passes through the power chassis 14, and, preferably, passes through a central region of the power chassis 14. In this way, the longitudinal axis 47 of the club bag 12 extends in a line that is forward of the rolling axis of the front wheels 22a, 22b and, therefore, also of the hub motors 21a, 21b. Further, in this embodiment, the club bag 12 is inclined such that no part of the club bag 12 extends in front of a forwardmost point 49 of the power chassis 14. This is a further feature that promotes the beneficial weight distribution of the golf bag assembly 10. In the illustrated embodiment, therefore, no part of the club bag 12 extends in front of the forwardmost part 49 of the battery unit 58 housed within the power chassis 14.

In one embodiment of the present invention, the two modes where the user is not pushing the cart and it is self-driven are the “Remote Mode” and the “Follow Mode” mode. In the “Remote Mode”, the user uses the remote 32 to communicate commands, through either pressing buttons or using a joystick, to the tracking antenna 50 which interacts with the main controller 56 to provide output commands to each hub motor 21a, 21b as to what speed and direction the hub motors 21a, 21b should turn at to properly control the front wheels 22a, 22b. If a more sophisticated control than buttons is used, such as a joystick, joypad, D-pad or other similar control interface, this would permit the user to have proportional control over the driving speed and/or steering direction of the golf bag assembly 10.

“Follow Mode” is similar to “Remote Mode”, but instead of the user using the joystick or arrow buttons to control the golf bag assembly 10. The user stands in front of the golf bag assembly 10 and presses the “follow” button. In this mode, the golf bag assembly 10 follows the user within a defined range (it will keep itself a set distance from the user and will slow/stop when it is within this range). To retake manual control of the golf bag assembly 10, the user presses the joystick or arrow buttons, and this disengages the “follow” function.

To be able to be folded into a compact form in the Transport Configuration and the Collapsed Configuration, the golf bag assembly 10 has a very small footprint, much smaller than previous self-powered carts and trolleys if the bag and trolley were attempted to be transported together. An issue that arises when having such a small collapsed footprint is the stability of a golf bag assembly when opened to be used. For the stability of a golf bag assembly 10, it is important that the wheel base for each of the front wheels 22a, 22b and the rear wheels 20a, 20b be as wide as possible. To achieve this on the front wheels 22a, 22b while maintaining the narrow width of the golf bag assembly 10 when the front wheels 22a, 22b are removed (i.e. this is the reason the hub motors 21a, 21b, in a preferred embodiment should be positioned no wider than approximately the width of the power chassis 14/club bag 12 of a golf bag assembly 10), the front wheels 22a, 22b should be designed with a deep draw where each front wheel 22a, 22b connects to its respective hub motor 21a, 21b, and the tread extends out to create the width required. Further, the rear wheels 20a, 20b, should, ideally, be as wide as possible while still being within the side pockets of the golf bag assembly 10, so as to not increase the overall width of the golf bag assembly 10. This restriction, as mentioned above, allows a golf bag assembly 10 to be used on the back of a golf cart or other vehicle. The golf bag assembly 10 of the present invention as depicted in the figures and, as explained above, addresses all of those design requirements. The disclosure herein and the figures provide exemplary angles and distances for one embodiment of the present invention. The dimensions depicted are in millimeters. It should be understood that the golf bag assembly 10 of the present invention is not limited to angles or measurements specifically disclosed herein or in any of the figures, and that various dimensions and angles could be used for different embodiments of the present invention.

Referring now to FIG. 3D, in an embodiment of the golf bag assembly 10, a counter-weight cavity 27 may be formed on the rear wheel support brace 17 between the rear wheels 20a, 20b. The counter-weight cavity 27 may be used to add counter-balance weights to improve the stability of the golf bag assembly 10 when driving downhill by assisting in preventing forward tipping that the golf bag assembly 10 may experience when stopping on the hill. In another embodiment, suspension, or some form of shock absorber, may be added to the rear wheel support brace 17, or to the rear wheels 20a, 20b directly, to limit the amount of bounce the powered golf bag assembly 10 may have in operation.

Now, referring to FIGS. 4A-4B, the Push Configuration, where the golf bag assembly 10 is not powered, and the user physically pushes the bag assembly 10, is depicted. This configuration is essentially the same configuration as the Powered Use Configuration, except now the user has disabled the power to the front wheels 22a, 22b and extended the telescoping handle 18 by pressing in on a handle release lever 19 and pulling up on the handle 18. In this configuration, the user can now push the bag assembly 10 during his round of golf.

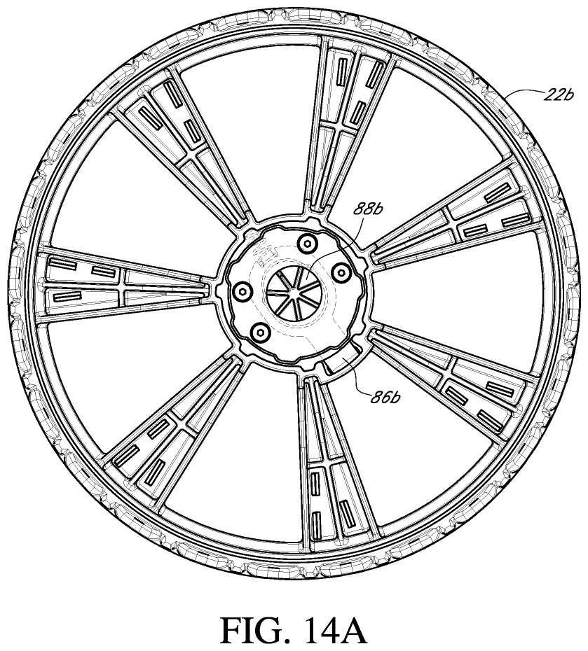

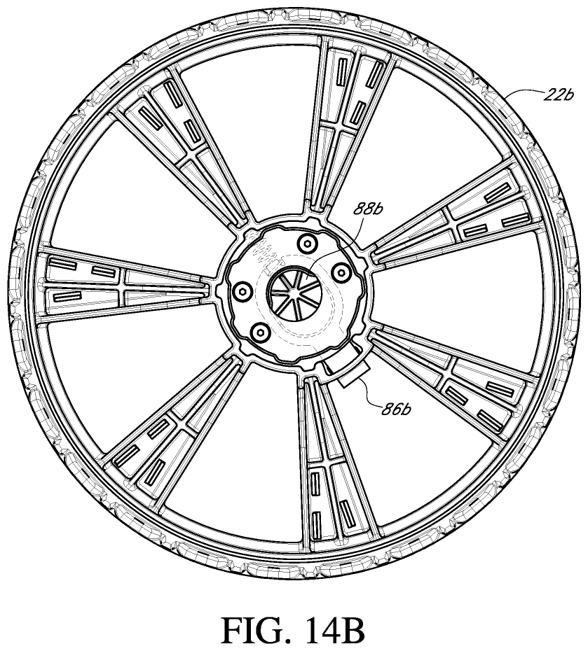

When the user of the golf bag assembly 10 is finished with a round of golf, in either the Powered Use Configuration or the Push Configuration and wants to collapse and transport the golf bag assembly 10, the user first disengages the locking mechanisms 76a, 76b and folds the rear wheel support brace 17 upward, around the pivot point 25, towards the rear bag support frame 15 and puts the golf bag assembly 10 in the Collapsed Configuration. Then, to put the golf bag assembly 10 in the Transport Configuration, as depicted in FIGS. 14A-14B, the user presses the release buttons 86a, 86b on the respective wheels 22a, 22b to disengage the wheels 22a, 22b from flanges 88a, 88b of the hub motors 21a, 21b and then pulls the front wheels 22a, 22b off of the hub motors 21a, 21b. The golf bag assembly 10 is now ready for transport. As mentioned above, to make the golf bag assembly 10 lighter for transport, the user may also remove the battery unit 58 from the power chassis 14.

Referring now to FIG. 15, another embodiment of the golf bag assembly 10 of the present invention is depicted. In this embodiment, components of the bag transport assembly 16 are integrated directly into the club bag 12. In this embodiment, a rear handle 90, that is used for pushing or directing the golf bag assembly 10, is integrated directly into the top of the club bag 12, and the rear wheel support brace 17 is integrated directly into the bottom of the club bag 12. The rear handle 90 and the rear wheel support brace 17, in this embodiment, are foldable to make transport of the golf bag assembly 10 easier, The rear handle 90 of this embodiment may also include a control pad 92 that a user uses to control the golf bag assembly 10. The control pad 92 may be formed into the rear handle 90 so it is not removeable or the control pad 92 may be removeable and used as a remote. In this embodiment, the golf bag assembly 10 has a battery unit 94 and a controller unit 96. The battery unit 94 and the controller unit 96, in this embodiment, are carried in a pouch 98. Wires 100a, 100b from the battery unit 94 and the controller unit 96 are connected to the hub motors 21a, 21b in the front wheels 22a, 22b of the golf bag assembly 10. In this embodiment, in contrast to prior embodiments, the hub motors 21a, 21b are integrated directly with the front wheels 22a, 22b.

Although the golf bag assembly has been described based on the embodiments disclosed and explained above, it should be noted that this golf bag assembly may be altered without escaping the intended scope of the described invention.

What is claimed is:

1. A powered golf bag assembly, comprising:
a club bag;
a bag transport assembly integrated with the club bag, wherein the bag transport assembly comprises a foldable rear wheel support brace and a power chassis; wherein the foldable rear wheel support brace includes a plurality of wheels and the power chassis comprises:
a battery;
a controller; and
a plurality of hub motors in communication with the battery and the controller.

2. The powered golf bag assembly of claim 1, further comprising a plurality of removeable wheels that each correspond to a hub motor, wherein the removeable wheel can be removed from or installed on a corresponding hub motor.

3. The powered golf bag assembly of claim 2, wherein each hub motor has splines formed thereon around the outer diameter, and each corresponding removeable wheel has female spline cups formed therein, to engage the splines of the corresponding hub motor when the removeable wheel is installed.

4. The powered golf bag assembly of claim 1, wherein the battery is removeable.

5. The powered golf bag assembly of claim 1, further comprising:
an antenna disposed in the bag transport assembly; and
a remote; wherein the antenna and the remote interact with one another to track and control the powered golf bag assembly.

6. The powered golf bag assembly of claim 5, wherein the antenna is ultra-wide band.

7. The powered golf bag assembly of claim 1, wherein the plurality of hub motors is a pair of hub motors, and each hub motor operates independent of one another.

8. The powered golf bag assembly of claim 1, wherein the club bag has a top and when the foldable rear wheel support brace is folded against the club bag, the highest point of the foldable rear wheel support brace is below the top of the club bag.

9. A powered golf bag assembly, comprising:
a club bag having a compartment;
a battery;
a controller, wherein the battery and the controller are configured to be carried in the compartment of the club bag;
a foldable handle;
a foldable rear wheel support brace having a plurality of wheels, wherein the foldable handle and foldable rear wheel support brace are integrated with the club bag, and
a pair of front wheels having a hub motor for each wheel; wherein each hub motor is in communication with the battery and the controller and the pair of front wheels connect to the club bag.

10. The powered golf bag assembly of claim 9, wherein the pair of front wheels are removeable from the club bag.

11. A powered golf bag assembly, comprising:
a club bag having a base with a defined width;
a bag transport assembly configured to connect to the club bag, wherein the bag transport assembly comprises a foldable rear wheel support brace and a power chassis; wherein the foldable rear wheel support brace includes a plurality of wheels and the power chassis has a top portion that has a defined width that is approximately the same width as the base of the club bag, and wherein the power chassis comprises:
a battery;
a controller;
a shell; and
a pair of hub motors in communication with the battery and the controller and mounted external to the shell; wherein, when mounted external to the shell, each hub motor has an outer edge and the width defined from outer edge of the first hub motor to the outer edge of the second hub motor is less than the width of the base of the club bag.

12. The powered golf bag assembly of claim 11, wherein the defined width of the base of the club bag is approximately 267.7 millimeters.

13. The powered golf bag assembly of claim 11, wherein the plurality of wheels of the foldable rear wheel support brace is a pair of wheels and each wheel of the foldable rear wheel support brace has an outer edge and the width defined from the outer edge of the first wheel of the foldable rear wheel support brace to the outer edge of the second wheel of the foldable rear wheel support brace is approximately 462 millimeters.

14. The powered golf bag assembly of claim 11, further comprising a pair of removeable wheels that each correspond to one of the hub motors, wherein the removeable wheel can be removed from or installed on a corresponding hub motor.

15. The powered golf bag assembly of claim 14, wherein each removeable wheel has an outer edge and the width defined from outer edge of the first removeable wheel to the outer edge of the second removeable wheel is approximately 585.5 millimeters.

16. The powered golf bag assembly of claim 14, wherein the club bag has a centerline, and the pair of removeable wheels define a central axis between them, and wherein the club bag centerline extends forward of the central axis of the removeable wheels.

17. The powered golf bag assembly of claim 14, wherein each hub motor has splines formed thereon around the outer diameter, and each corresponding removeable wheel has female spline cups formed therein, to engage the splines of the corresponding hub motor when the removeable wheel is installed.

18. The powered golf bag assembly of claim 11, wherein the shell has a forwardmost point and wherein, when the club bag is in an inclined position, no portion of the club bag extends in front of the forwardmost point of the shell.

19. The powered golf bag assembly of claim 11, wherein the battery is removeable.

20. The powered golf bag assembly of claim 11, further comprising:
an antenna disposed in the bag transport assembly; and
a remote; wherein the antenna and the remote interact with one another to track and control the powered golf bag assembly.
